(19) United States
(12) Patent Application Publication
(10) Pub. No.: US 2026/0080223 A1
(43) Pub. Date: Mar. 19, 2026

(54) Alignment of Artificial Intelligence Models using Models of Physiological Response Patterns

(71) Applicant: BRAINVIVO LTD., Tel Aviv (IL)

(72) Inventors: Shlomi Lifshits, Tel Aviv (IL); Assaf Horowitz, Tel Aviv (IL)

(21) Appl. No.: 18/889,442

(22) Filed: Sep. 19, 2024

(51) Int. Cl. G06N 3/0475

(52) U.S. Cl. CPC G06N 3/0475

(57) ABSTRACT

A method for performing artificial intelligence (AI) alignment on a generative AI model (GAIM), the method includes receiving a content item, which is generated by the GAIM. A computerized brain model, which has been trained to simulate responses of at least one human to content items generated by the GAIM, is applied to the content item. The AI alignment is performed on the GAIM based on a simulated response of the computerized brain model to the content item.

### FIELD OF THE INVENTION

The present invention relates generally to Artificial intelligence (AI), and particularly to methods and systems for improving alignment of AI models.

### BACKGROUND OF THE INVENTION

Neurophysiological modeling and brain encoding and decoding are described in various publications.

For example, U.S. Patent Application Publication 2020/0170524 describes a computer implemented method includes supplying stimuli to an organism, measuring brain activity of the organism responsive to the stimuli and producing a brain feature activity map characterizing the brain activity.

U.S. Patent Application Publication 2021/0241065 describes a content classification method includes receiving a set of content items from categories of a specific discipline and extracting respective features from each content item.

U.S. Patent Application Publication 2024/0016438 describes a method for content delivery, the method includes dividing a reference group of human subjects into multiple segments according to one or more segmentation criteria. Subjective responses of the human subjects to a reference set of data items are collected, and neurophysiological responses of the human subjects to the data items in the reference set are measured. The human subjects are classified into multiple brain types according to the measured neurophysiological responses. Based on the collected subjective responses, a mapping is defined between the segmentation criteria and the brain types and is applied in predicting a brain type of a human subject outside the reference group. A content offering is selected for presentation to the human subject responsively to the predicted brain type.

Moreover, training of AI models includes alignment, which is a process of encoding human values and additional features into AI-based models. Various techniques have been used for performing AI alignment, for example, in alignment training, AI model providers may use a large number (e.g., hundreds or thousands) of people to manually tag content generated by the AI model. Such a training process may take a long time, cost a lot of money, and may result in errors and inaccuracies, inter alia, due to non-uniformity and inconsistency in the tagging process.

For example, Kenton et al. “Alignment of language agents.” arXiv preprint arXiv:2103.14659 (2021), describe behavioral issues for language agents, arising from accidental misspecification by the system designer. Kenton et al. further describe some ways that misspecification can occur and discuss some behavioral issues that could arise from misspecification, including deceptive or manipulative language. Moreover, Wolf et al. arXiv preprint arXiv:2304.11082 (2023), described fundamental limitations of alignment in large language models.

### SUMMARY OF THE INVENTION

An embodiment of the present invention that is described herein provides a method for performing artificial intelligence (AI) alignment on a generative AI model (GAIM), the method includes receiving a content item, which is generated by the GAIM. A computerized brain model, which has been trained to encode or simulate a brain response of at least one human to content items, is applied to the content generated by the GAIM. The AI alignment is performed on the GAIM based on a simulated response of the computerized brain model to the content item.

In some embodiments, the computerized brain model has been trained based on physiological parameters indicative of a physiological reaction of the at least one human to at least some of the content items. In other embodiments, applying the computerized brain model includes receiving, based on the simulated response, a simulated human labeling of the at least one human to the content item. In yet other embodiments, the content item includes an image of a design of an object, and applying the computerized brain model includes receiving the simulated human labeling of the design.

In some embodiments, the design of the object is produced by an apparatus, and the method includes, based on the AI alignment, controlling the apparatus to alter the design of the object. In other embodiments, the content item includes an audio file of at least one of a tune and a melody of a song or a piece, and applying the computerized brain model includes receiving the simulated human labeling of the at least one of the tune and the melody.

In some embodiments, the method includes receiving an additional content item generated by the GAIM and altering at least the additional content item based on the AI alignment. In other embodiments, applying the computerized brain model includes receiving a simulated human labeling indicating that the content item includes inappropriate content or undesired content, and performing the AI alignment includes adjusting the GAIM to alter or remove the inappropriate content or the undesired content in response to receiving the simulated human labeling.

In some embodiments, the computerized brain model is based on neurophysiological measurements including at least one of (i) brain imaging or a brain recording device, (ii) pupillometry, (iii) ocular measurements, and (iv) nerve conducting measurements. In other embodiments, performing the AI alignment includes (i) based on the simulated response of the computerized brain model to the content item, performing on the GAIM a first AI alignment having a first alignment accuracy, (ii) receiving an additional content item generated by the GAIM responsively to the first AI alignment, (iii) applying the computerized model to the additional content item, and receiving an additional simulated response of the at least one human to the additional content item, and (iv) based on the simulated response of the computerized brain model to the additional content item, performing on the GAIM a second AI alignment having a second alignment accuracy, different from the first alignment accuracy. In yet other embodiments, performing the AI alignment includes performing an iterative AI alignment process including at least the first AI alignment and the second AI alignment, and the second alignment accuracy is higher than the first alignment accuracy.

In some embodiments, the computerized brain model encodes or simulates a brain response related to specific cognitive systems, such as the emotional, value, reward, curiosity, Attention, sensory perception, memory, language, decision-making, intuition and judgement systems.

There is additionally provided, in accordance with an embodiment of the present invention, a system for performing artificial intelligence (AI) alignment on a generative AI model (GAIM), the system includes an interface and a processor. The interface is configured to receive a content item. The processor is configured to: (i) apply to the content item a computerized brain model, which has been trained to simulate responses of at least one human to content items generated by the GAIM, and (ii) perform the AI alignment on the GAIM based on a simulated response of the computerized brain model to the content item.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for generating a computerized brain model, in accordance with an embodiment of the present invention;

FIG. 2 is a block diagram that schematically illustrates a method for using the computerized brain model of FIG. 1 for performing alignment on a generative AI model, in accordance with an embodiment of the present invention; and

FIG. 3 is a flow chart that schematically illustrates a method for using the computerized brain model of FIG. 1 for performing alignment on a generative AI model, in accordance with an embodiment of the present invention.

### DETAILED DESCRIPTION OF EMBODIMENTS

### Overview

Generative artificial intelligence (AI) models (GAIMs) are trained to create new and original content such as conversational text, images, videos, and music. For example, GAIM training steps designed to create conversational content include: (a) sentence completion, (b) answering questions, and finally (c) alignment.

Alignment is the process of encoding human values and goals into AI-based models, such as large language models (LLMs), to make them as useful, safe, and reliable as possible. Through alignment, organizations can adapt AI models according to their business rules and policies. For example, during the alignment phase, the GAIM is trained to conduct a dialogue and give a person who is chatting with the GAIM a feeling that the GAIM is helpful, honest, harmless, and humanized (for example, in case the answers of the GAIM make the person happy and other cognitive values).

As a result of the alignment training, the GAIM should, among other things, refuse to produce content that has been defined to be inappropriate in the alignment training, e.g., offensive textual answers that could insult the user, or offensive graphic content (e.g. pornography).

For the alignment training phase, GAIM producers may use many (usually low-paid) people to manually tag content generated by the GAIM. Such a training process may be inconsistent (e.g., among different people and by a given person over time), take a long time, and may cost a lot of money.

The manual tagging process may be affected by inconsistency between different people, and even within the same person over time, and may sometimes result in the creation of generative content that may be controversial, and sometimes also absurd and offensive. For example, improper alignment training of the GAIM may result in generating an image of racially diverse Nazis. Moreover, the level of personal adjustment of the GAIM to a specific user may be insufficient, and as a result, may force the user to perform several iterations with the GAIM until s/he receives the desired output. For example, in response to a textual instruction from the user, an AI-based diffusion model displays a large number of images, and in an iterative process the user selects images that appear closer to the appropriate output and adds more textual instructions until the obtained output image is sufficiently close to the image the user saw in his/her imagination when started the session with the GAIM.

In other words, the present alignment training processes require manual tagging by humans, which increases the costs and cycle time of such processes, and the quality (e.g., accuracy and resolution) of the output received from GAIMs after alignment training may be insufficient.

Embodiments of the present invention that are described hereinbelow provide improved techniques for performing alignment on artificial intelligence (AI) models using data prepared based on pattern models of physiological responses. The disclosed techniques describe methods and systems for improving AI alignment applied to GAIM using a computerized brain model generated based on content items, labeling of the content items, and physiological response to the content items, as will be described in detail below.

In the context of the present disclosure and in the claims, the term GAIM refers to any suitable type of a computerized learning model that can be trained to generate new content and ideas, such as but not limited to conversations, stories, images, videos, and music, and is typically implemented in one or more types of neural networks.

In the context of the present disclosure and in the claims, the term Alignment refers to any process that is an integral part of training or building a computerized learning model that requires the feedback, response, or an interaction with an external agent, such as but not limited to human, humanoid (any mechanical form that incorporated with a humanized model) or a human-like computerized model.

In some embodiments, the computerized brain model is generated by receiving a training dataset comprising: (i) content items (e.g., text, image, video, and sound), (ii) labeling of the content items performed by one or more humans, and (iii) physiological parameters indicative of physiological reactions of the humans to brain stimuli generated in response to receiving the content items. Such techniques for generating computerized brain models are described in detail, for example, in U.S. Patent Application Publications 2020/0170524 and 2021/0241065, whose disclosures are incorporated herein by reference.

It is noted that the computerized brain model may be generated for various applications, and in some embodiments, the computerized brain model can be used to perform AI alignment on GAIMs without intervention of humans in the alignment training of the GAIM. In other words, the alignment training of the GAIM is carried out based on the computerized brain model.

In some embodiments, a method for performing the AI alignment on the GAIM comprise: (i) receiving the content items, and extracting features from the content items, (ii) applying the aforementioned computerized brain model to the content item, and receiving (from the computerized brain model) one or more simulated responses of the one or more humans to the content items generated by the GAIM, and (iii) performing the AI alignment on the GAIM based on the simulated responses described above. In some embodiments, the simulated responses may comprise a simulated human labeling of at least one of the humans to the content item. The labeling may comprise technical comments, as well as emotional comments, as will be described below.

In some embodiments, the computerized brain model encodes or simulates a brain response related to specific cognitive systems, such as the emotional, value, reward, curiosity, Attention, sensory perception, memory, language, decision-making, intuition and judgement systems.

The disclosed techniques may be implemented in several use cases and applications. In an example implementation, in response to textual prompting from a user, a diffusion based GAIM may generate an image of an interior design of a living room. Based on the disclosed techniques, a computerized brain model, which has been trained to simulate responses of a specific interior-design architect, may be applied to the image generated by the GAIM. In the present example, the simulated responses may comprise one or more simulated labels (e.g., comments) of the architect that are associated with several aspects of the interior design. The labeling may comprise technical comments (e.g., on geometrical ratios and positioning of items in the living room), as well as emotional comments on the design (e.g., beautiful, ugly).

In some embodiments, based on the simulated labels and performing AI alignment, the computerized brain model may be used to drive improvements in the output generated by the diffusion based GAIM. In other words, the computerized brain model may be used to improve the resolution of the AI alignment and to add more layers of AI alignment, such as how the designer feels about the design generated by the GAIM.

In some embodiments, the disclosed techniques may be used to perform AI alignment based on various brain models, such as (i) additional versions of the computerized brain model of the specific architect over time, (ii) another version of the computerized brain model based on a group of architects having a similar approach to interior design of living rooms, and (iii) any other types of computerized brain models suitable for interior design of living rooms. It is noted that this implementation may be used to quantify and encode subjective comments (e.g., of the specific architect) and apply them to actionable AI-based alignment of a generic AI model.

In other embodiments, the disclosed techniques may be implemented to generate and apply a computerized brain model, which is based on business rules and policies of a predefined society or organization. For example, a computerized brain model may be generated, based on the techniques described above, to label inappropriate content (e.g., child abuse) based on responses received from a group of people that are implementing the business rules and policies conducted by the predefined society or organization. As such, the AI alignment of generic AI models is carried out based on a computerized brain model, which is perceived objective in accordance with the business rules and policies of the predefined society or organization.

Additionally, or alternatively, the computerized brain model may be generated based on a specific type of population defined by unique cultural properties, and the AI alignment may be targeted to address the moral standards of the specific type of population. Moreover, this implementation of the disclosed techniques may replace the expensive and inconsistent manual tagging of content items described above, and thereby, reduce implementation time and costs, and improve the accuracy and consistency of content items generated by the GAIM.

### System Description

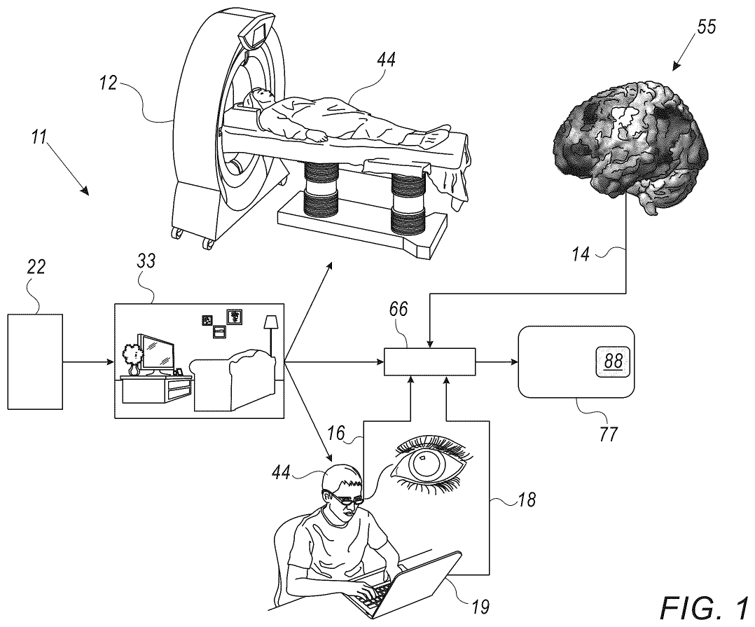

FIG. 1 is a schematic, pictorial illustration of a system 11 for generating a computerized brain model 88, in accordance with an embodiment of the present invention.

In some embodiments, system 11 comprises a generative AI model (GAIM) 22, which is configured to generate images in response to receiving descriptive prompts from a user (not shown). In the present example, the user prompt includes generating an image 33 of an internal design of a living room. In other examples, the user prompt may comprise any other input, such as but not limited to an audio file of a tune and/or a melody, of a song or a piece.

In some embodiments, system 11 is configured to generate computerized brain model 88 of one or more humans, in the present example, computerized brain model 88 (also referred to herein as brain model 88 for brevity) of a professional interior designer referred to herein as a designer 44, for brevity.

In some embodiments, system 11 is configured to display to designer 44 one or more content items, such as image 33, and in response to one or more queries, receive from designer 44 (e.g., using a suitable computing device 19) one or more labels 18 associated with properties of the design shown in image 33. Additionally, or alternatively, system 11 is configured to play the tune or the melody described above. It is noted that in addition to receiving labels 18, system 11 is configured to receive signals indicative of measured physiological responses of designer in response to stimuli caused by image 33 or any other sort of content item. The measured physiological responses may comprise neurophysiological measurements, such as brain measurements performed by one or more of anatomical Magnetic Resonance Imaging (MRI) systems 12, Diffusion Tensor Imaging (DTI), Functional MRI (fMRI) 55, Electroencephalogram (EEG), Magnetoencephalogram (MEG), Infrared Imaging, Ultraviolet Imaging, Computed Tomography (CT), Brain Mapping Ultrasound, In-Vivo Cellular Data, In-Vivo Molecular data, genomic data, optical imaging and functional near-infrared spectroscopy (fNIRS). Additionally, or alternatively, interface 66 of system 11 is configured to receive measurements of the dilation of pupils of the eyes of designer 44, as well as other sorts of measurements of physiological reactions, such as but not limited to blood pressure, and heartbeat rate. Moreover, interface 66 is configured to receive signals indicative of nerve conducting measurements, such as but not limited to (i) electromyography (EMG) of muscle response or electrical activity in response to a nerve's stimulation of the muscle, and (ii) electrocardiogram (ECG). In some embodiments, controllers of such nerve conducting measurement devices (e.g., EMG, ECG) have been trained to simulate a neurophysiological responses of at least one human.

In some embodiments, system 11 comprises an interface 66, which is configured to receive signals indicative of image 33, labels 18, and the physiological measurements, in the present example, measurements of fMRI 14, and pupil size 16 carried out using pupillometry, while designer 44 reviews and assigns the labels to the design in image 33 (and/or while a musician reviews the tune and/or melody described above, and assigns labels thereto). Additionally, or alternatively, interface 66 is configured to receive signals from any suitable type of an eye tracking device, the signals may be indicative of ocular measurements, such as gaze direction, pupil size, blink rate, and other suitable type of measured physiological responses.

In some embodiments, system 11 comprises a processor 77, which is configured to extract features from image 33 (and other sorts of content items received by interface 66), and physiological parameters indicative of the measured physiological reactions, such as the measurements of fMRI 14, and pupil size 16.

In some embodiments, processor 77 comprises any suitable type of a central processing unit (CPU), or a graphical processing unit (GPU), or a tensor processing unit (TPU) or any other suitable type of an application-specific integrated circuit (ASIC). All the above processing units are configured, inter alia, to accelerate deep learning workloads in a neural network. Additionally, or alternatively, system 11 may comprise any suitable type of an ASIC and/or a digital signal processor (DSP) and/or any other suitable sort of processing unit configured to carry out at least part of the processing of data in system 11. All these types of processing units are programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

In some embodiments, based on the (i) features of image 33, (ii) labels 18, and (iii) the physiological parameters described above, processor 77 is configured to generate brain model 88, which has been trained to simulate responses of at least one human (e.g., designer 44) to content items (such as the design shown in image 33) generated by GAIM 22. Additionally, or alternatively, applying the computerized brain model 88 comprises receiving the simulated human labeling of the tune and/or melody, as described above.

Techniques for generating brain models are further described in detail, for example, in U.S. Patent Application Publications 2020/0170524, 2021/0241065, and 2024/0016438, whose disclosures are incorporated herein by reference.

In other embodiments, brain model 88 may be generated using any other suitable type of content items, such as but not limited to text produced by a LLM, image, video, and sound. Moreover, based on the techniques described above, system 11 is configured to generate (i) additional versions of brain model 88 of designer 44 over time, and (ii) another version of the computerized brain model, which is based on a group of interior designers (including or excluding designer 44) having a similar approach to interior design of living rooms. It is noted that in these use cases, the brain models may be generated for performing AI-based alignment on specific tasks of GAIMs (e.g., generating images of interior design). Moreover, these brain models are generated based on content items belonging to specific disciplines, and the response pattern models of one or more professional humans savvy in these specific disciplines.

Additionally, or alternatively, system 11 is configured to generate any other types of computerized brain models, which are based on business rules and policies of a predefined society or organization. For example, based on a set of policies for defining content being inappropriate in a given country, the disclosed techniques, and responses received from a group of people implementing these policies, system 11 is configured to generate a brain model for labeling several types of inappropriate content (e.g., violence, porn, and child abuse) in the given country. Moreover, system 11 is configured to generate one or more brain models suitable for AI alignment of GAIMs by replacing designer 44 with multiple groups of people representing multiple different respective cultures, and applying the disclosed techniques to the people in each of these groups. Techniques for generating brain models targeted for specific segments are described, for example, in U.S. Patent Application Publication 2024/0016438, whose disclosure is incorporated herein by reference.

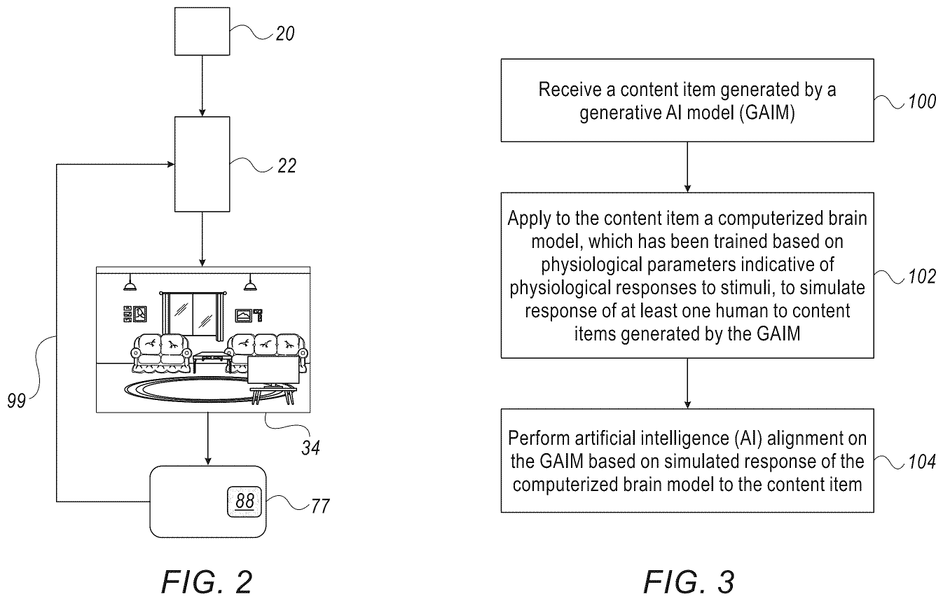

FIG. 2 is a block diagram that schematically illustrates a method for using brain model 88 to perform AI alignment on GAIM 22, in accordance with an embodiment of the present invention.

In some embodiments, in response to textual prompting 20 from a user (not shown), GAIM 22 generates an image 34 of an interior design of a living room, note that the design in image 34 is different from that of image 33 of FIG. 1 above. Interface 66 (shown in FIG. 1 above) receives image 34, and processor 77 is configured to apply brain model 88, which has been trained to simulate responses of designer 44 to images, such as image 34 (and optionally any other sort of content items received from GAIM 22).

In some embodiments, brain model 88 is configured to generate simulated alignment-related responses of designer 44 to image 34. In the present example, the simulated responses may comprise one or more simulated labels (e.g., comments) of the architect that are associated with several aspects of the interior design shown in image 34.

In some embodiments, the labeling may comprise one or more words expressing the simulated response of designer 44 to elements in the designed living room of image 34. For example, the labeling may comprise one or more of: (i) technical comments on the design (e.g., the table is too low, the color of the sofa is too bright, and the TV should be positioned 5 inches higher), and (ii) emotional comments on the design (e.g., the structure of the living room gives a spacious feeling, the texture of the wall surrounding the TV is ugly, and the colors are boring). It is noted that the emotional comments simulate how designer 44 would have been feeling, and reacting when viewing image 34.

In some embodiments, processor 77 is configured to output the simulated responses of designer 44 that have been generated by brain model 88, for performing the AI alignment 99 to GAIM 22.

In some embodiments, in response to the AI alignment 99, GAIM 22 generates one or more additional images of improved designs of the living room shown in image 34, and the iterative process repeats until the response from brain model 88 comprises only positive comments and/or a concluding comment, such as “very good,” or any other suitable simulated response typical to designer 44.

It is noted that the AI alignment 99 performed on GAIM 22 does not require any intervention of a human, such as designer 44. In other words, the AI alignment 99 is fully automatic, and therefore, faster, cheaper, and more consistent compared to manual alignment processes that are based on responses from humans, as described above. Moreover, brain model 88 improves the resolution, accuracy, and customization of the alignment by adjusting the alignment applied to a brain model of a specific designer preferred by the user. As such, the AI alignment 99 can drive improvements in the output generated by GAIM 22 to meet the requirements of the user of GAIM 22.

In some embodiments, the application of brain model 88 adds more layers to the AI alignment 99, such as the emotional comments indicative of how the designer feels about the design generated by GAIM 22.

In some embodiments, the disclosed techniques may be used, mutatis mutandis, to perform AI alignment based on various types of brain models, such as performing the alignment based on a different version of brain model 88 of designer 44. For example, a version of brain model 88 that was generated after visiting a conference in which new inspiring design concepts have been presented to designer 44.

In other embodiments, processor 77 is configured to perform alignment on an AI model designed for other AI applications, by applying any suitable type of brain model, instead of brain model 88. For example, in an AI application related to customer service of a predefined product or service, the interaction between LLMs and users may require different alignment in different cultures. In this example, the techniques described in FIG. 1 above may be used, with necessary changes, to generate first and second different brain models for alignment applied to LLMs designed for customer service in Germany and Brazil, respectively. With reference to FIG. 1 above, (i) instead of image 33 the AI model produces examples of sentences related to customer service of the respective product or service, and (ii) selected groups of German and Brazilian users of the aforementioned product or service will be used for generating the brain model instead of designer 44. It is noted that the first and second brain models will be based on the specific language and cultural differences of these countries. Moreover, during the alignment, the LLMs are trained to conduct a dialogue and provide the (client) user of the LLM with a feeling that the LLM is helpful, honest, harmless, and humanized, in accordance with the cultural differences between Germans and Brazilians. In other words, some answers may be acceptable in one culture and perceived to be annoying in another culture.

In alternative embodiments, system 11 may comprise or may be connected to an apparatus configured to generate any physical material or has the capability to alter a physical substance. For example, the apparatus may comprise a three-dimensional (3D) printer (not shown) configured to produce a 3D object by applying a 3D printing process. In such embodiments, processor 77 is configured to perform alignment on the 3D object in real-time, e.g., while the 3D object is being printed. Moreover, based on the output of the AI alignment process, processor 77 is configured to control the 3D printer (or a controller of the 3D printer) to change the design of the 3D object during the printing process. Additionally, or alternatively, the technique described above may be applied to other sort of apparatus or system configured to perform other processes, such as but not limited to a drawing of a paint, fabrication of a dish or any suitable type of food using a robotic arm. Moreover, the disclosed techniques may be used, mutatis mutandis, for receiving (e.g., an image of) an additional content item generated by the GAIM, and based on the AI alignment, processor 77 is configured to alter at least one property of at least the additional content item.

This particular configuration of system 11 and block diagram of FIG. 2 are shown by way of example, in order to illustrate certain problems related to alignment of AI models that are addressed by embodiments of the present invention and to demonstrate the application of these embodiments in enhancing the performance of generative AI models. Embodiments of the present invention, however, are by no means limited to this specific sort of example GAIM 22, and the principles described herein may similarly be applied to perform alignment on other sorts of AI models used in any suitable generative AI applications. For example, the techniques described above may be applied to other content items, such as but not limited to an audio file of a tune and/or melody, of a song or a piece, and the computerized brain model 88 receives the simulated human labeling of the tune or melody to perform the AI alignment on the GAIM 22.

FIG. 3 is a flow chart that schematically illustrates a method for using brain model 88 for performing alignment on GAIM 22, in accordance with an embodiment of the present invention.

The method begins at a content item receiving step, with receiving a content item, such as image 34, generated by GAIM 22, as described in detail in FIG. 2 above.

At a brain model application step 102, brain model 88 that has been trained based on physiological parameters indicative of physiological responses of designer 44 to stimuli (such as image 33), is applied to image 34 as described in detail in FIGS. 1 and 2 above.

At an AI alignment step 104 that concludes the method, the simulated response from brain model 88 is used to perform AI alignment 99 to GAIM 22, as described in detail in FIG. 2 above.

In some embodiments, the method is applicable to other AI alignment applications, such as but not limited to an audio file of a tune and/or melody, of a song or a piece. And the computerized brain model 88 receives the simulated human labeling of the tune or melody to perform the AI alignment on the GAIM 22 or any other GAIM configured to generate the tune and/or melody of the song or piece, as described in FIGS. 1 and 2 above.

Although the embodiments described herein mainly address performing AI alignment on generative AI models, the methods and systems described herein can also be used in other applications, such as in performing AI alignment on other sorts of AI models.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for performing artificial intelligence (AI) alignment on a generative AI model (GAIM), the method comprising:
receiving a content item, which is generated by the GAIM;
applying to the content item a computerized brain model, which has been trained to simulate responses of at least one human to content items generated by the GAIM; and
performing the AI alignment on the GAIM based on a simulated response of the computerized brain model to the content item.

2. The method according to claim 1, wherein the computerized brain model has been trained based on physiological parameters indicative of a physiological reaction of the at least one human to at least some of the content items.

3. The method according to claim 1, wherein applying the computerized brain model comprises receiving, based on the simulated response, a simulated human labeling of the at least one human to the content item.

4. The method according to claim 3, wherein the content item comprises an image of a design of an object, and wherein applying the computerized brain model comprises receiving the simulated human labeling of the design.

5. The method according to claim 4, wherein the design of the object is produced by an apparatus, and comprising, based on the AI alignment, controlling the apparatus to alter the design of the object.

6. The method according to claim 3, wherein the content item comprises an audio file of at least one of a tune and a melody of a song or a piece, and wherein applying the computerized brain model comprises receiving the simulated human labeling of the at least one of the tune and the melody.

7. The method according to claim 1, and comprising receiving an additional content item generated by the GAIM, and altering at least the additional content item based on the AI alignment, which is based on the simulated response of the computerized brain model to the additional content item.

8. The method according to claim 1, wherein applying the computerized brain model comprises receiving a simulated human labeling indicating that the content item, or one of its compartments, comprises inappropriate content or undesired content, and wherein performing the AI alignment comprises adjusting the GAIM to alter or remove the inappropriate content or the undesired content, or one of their compartments, in response to receiving the simulated human labeling.

9. The method according to claim 1, wherein the computerized brain model is based on neurophysiological measurements comprising at least one of (i) brain imaging or a brain recording device, (ii) pupillometry, (iii) ocular measurements, and (iv) nerve conducting measurements.

10. The method according to claim 1, wherein performing the AI alignment comprises (i) based on the simulated response of the computerized brain model to the content item, performing on the GAIM a first AI alignment having a first alignment accuracy, (ii) receiving an additional content item generated by the GAIM responsively to the first AI alignment, (iii) applying the computerized model to the additional content item, and receiving an additional simulated response of the at least one human to the additional content item, and (iv) based on the simulated response of the computerized brain model to the additional content item, performing on the GAIM a second AI alignment having a second alignment accuracy, different from the first alignment accuracy.

11. The method according to claim 9, wherein performing the AI alignment comprises performing an iterative AI alignment process comprising at least the first AI alignment and the second AI alignment, and wherein the second alignment accuracy is higher than the first alignment accuracy.

12. A system for performing artificial intelligence (AI) alignment on a generative AI model (GAIM), the system comprising:
an interface, which is configured to receive a content item; and
a processor, which is configured to: (i) apply to the content item a computerized brain model, which has been trained to simulate responses of at least one human to content items generated by the GAIM, and (ii) perform the AI alignment on the GAIM based on a simulated response of the computerized brain model to the content item.

13. The system according to claim 12, wherein the computerized brain model has been trained based on physiological parameters indicative of a physiological reaction of the at least one human to at least some of the content items.

14. The system according to claim 12, wherein the processor is configured to apply the computerized brain model by receiving, based on the simulated response, a simulated human labeling of the at least one human to the content item.

15. The system according to claim 14, wherein the content item comprises an image of a design of an object, and wherein the processor is configured to apply the computerized brain model by receiving the simulated human labeling of the design.

16. The system according to claim 15, wherein the design of the object is produced by an apparatus, and wherein, based on the AI alignment, the processor is configured to control the apparatus to alter the design of the object.

17. The system according to claim 14, wherein the content item comprises an audio file of at least one of a tune and a melody of a song or a piece, and wherein the processor is configured to apply the computerized brain model by receiving the simulated human labeling of the at least one of the tune and the melody.

18. The system according to claim 12, wherein the interface is configured to receive an additional content item generated by the GAIM, and the processor is configured to alter at least the additional content item based on the AI alignment.

19. The system according to claim 12, wherein the processor is configured to: (i) apply the computerized brain model by receiving a simulated human cognitive labeling indicating that the content item, or one of its compartments, comprises inappropriate content or undesired content, according to at least one cognitive system, and (ii) perform the AI alignment by adjusting the GAIM to alter or remove the inappropriate content or the undesired content in response to receiving the simulated human cognitive labeling.

20. The system according to claim 12, wherein the computerized brain model is based on neurophysiological measurements comprising at least one of (i) brain imaging or brain recording device, (ii) pupillometry, (iii) ocular measurements, and (iv) nerve conducting measurements.

21. The system according to claim 12, wherein the processor is configured to perform the AI alignment on the GAIM by: (i) performing, based on the simulated response of the computerized brain model to the content item, a first AI alignment having a first alignment accuracy, (ii) receiving an additional content item generated by the GAIM responsively to the first AI alignment, (iii) applying the computerized model to the additional content item, and receiving an additional simulated response of the at least one human to the additional content item, and (iv) performing, based on the simulated response of the computerized brain model to the additional content item, a second AI alignment having a second alignment accuracy, different from the first alignment accuracy.

22. The system according to claim 12, wherein performing the AI alignment comprises performing an iterative AI alignment process comprising at least the first AI alignment and the second AI alignment, and wherein the second alignment accuracy is higher than the first alignment accuracy.
